(19) United States
(12) Patent Application Publication
(10) Pub. No.: US 2013/0034063 A1
(43) Pub. Date: Feb. 7, 2013

(54) COMBINATIONS OF SPACE-DIVERSITY, FREQUENCY-DIVERSITY AND ADAPTIVE-CODE-MODULATION

(71) Applicant: Gur BALLAS, Tel-Mond (IL)

(72) Inventor: Gur BALLAS, Tel-Mond (IL)

(73) Assignee: Ceragon Networks Ltd., Tel-Aviv (IL)

(21) Appl. No.: 13/563,895

(22) Filed: Aug. 1, 2012

Related U.S. Application Data
(60) Provisional application No. 61/513,726, filed on Aug. 1, 2011.

(51) Int. Cl. H04W 72/04

(52) U.S. Cl. 370/329

(57) ABSTRACT

A method of communicating bi-directionally over a wireless communication system including sending data from a first location, from a first antenna, over a first plurality of signals at different frequencies, to a second plurality of spatially separated antennas at a second location, each of the second plurality of spatially separated antennas feeding a corresponding transmitter/receiver of a plurality of transmitter/receivers at the second location. A method of communicating over a wireless communication system including transmitting same data from a first location, using each one of a plurality of Adaptive Coding and Modulation (ACM) signals at different frequencies, to receivers corresponding to each one of the frequencies at a second location, receiving the transmitted signals, and combining the received signals. Related apparatus and methods are also described.

### RELATED APPLICATION

This application claims the benefit of priority under 35 USC 119(e) of U.S. Provisional Patent Application No. 61/513,726 filed Aug. 1, 2011, the contents of which are incorporated herein by reference in their entirety.

### FIELD AND BACKGROUND OF THE INVENTION

The present invention, in some embodiments thereof, relates to the field of wireless communication and, more specifically but not exclusively, to wireless communication systems such as employed by cellular backhaul networks or other wireless networks in microwave and millimeter waves.

Quality of a wireless communication link is often measured in terms of availability. For example—an average number of seconds per year in which service is not provided due to fading in the wireless link. In order to guarantee quality, care must be taken in designing the wireless link with respect to channel conditions and interference.

The disclosures of all references mentioned above and throughout the present specification, as well as the disclosures of all references mentioned in those references, are hereby incorporated herein by reference.

### SUMMARY OF THE INVENTION

Measures which may be taken in order to increase availability in a wireless communication link include, by way of a non-limiting example: Space Diversity (SD), Frequency Diversity (FD), and Adaptive Coding and Modulation (ACM).

Some embodiments of the invention use a combination of the above measures, producing potential benefits arising from different strengths and weaknesses inherent in the different measures.

According to an aspect of some embodiments of the present invention there is provided a method of communicating bi-directionally over a wireless communication system including sending data from a first location, from a first antenna, over a first plurality of signals at different frequencies, to a second plurality of spatially separated antennas at a second location, each of the second plurality of spatially separated antennas feeding a corresponding transmitter/receiver of a plurality of transmitter/receivers at the second location.

According to some embodiments of the invention, further including combining the signals received by at least some of the receivers of the second location.

According to some embodiments of the invention, the combining includes selecting a best signal from the plurality of signals at different frequencies received by the plurality of spatially separated antennas of the second location.

According to some embodiments of the invention, the combining includes adding the received signals using an appropriate phase shift. According to some embodiments of the invention, the combining includes adding the received signals using an appropriate gain.

According to some embodiments of the invention, the communicating is via a continuous carrier wireless point-to-point communication system. According to some embodiments of the invention, the communicating is via a single carrier wireless communication system.

According to some embodiments of the invention, the plurality of signals include three frequencies. According to some embodiments of the invention, the plurality of spatially separated antennas includes two antennas.

According to some embodiments of the invention, the sending of data includes sending same data over the plurality of signals. According to some embodiments of the invention, the sending data includes sending different data over different ones of the plurality of signals. According to some embodiments of the invention, the sending of data includes partly sending same data over different ones of the plurality of signals and partly sending different data over different ones of the plurality of signals.

According to some embodiments of the invention, the sending of data includes using Adaptive Coding and Modulation (ACM).

According to some embodiments of the invention, the sending of data includes decreasing a bit rate of the sending in one or more frequencies. According to some embodiments of the invention, the sending of data includes increasing a bit rate of the sending in one or more frequencies.

According to some embodiments of the invention, further including sending data from the second location, from at least some of the second plurality of spatially separated antennas, over a second plurality of signals at different frequencies, to the first antenna at the first location, the first antenna feeding a transmitter/receiver at the first location.

According to an aspect of some embodiments of the present invention there is provided a method of communicating over a wireless communication system including transmitting same data from a first location, using each one of a plurality of Adaptive Coding and Modulation (ACM) signals at different frequencies, to receivers corresponding to each one of the frequencies at a second location, receiving the transmitted signals, and combining the received signals.

According to some embodiments of the invention, further including using ACM to reduce a communication rate in the different frequencies.

According to an aspect of some embodiments of the present invention there is provided a wireless communication system including at a first location: a first transmitter/receiver configured for transmitting and receiving over a plurality of frequencies, and a first antenna connected to the first transmitter/receiver for transmitting and receiving the plurality of frequencies of the first transmitter/receiver, and, at a second location: a second plurality of spatially separated antennas for receiving transmissions from the first antenna, a second plurality of corresponding transmitter/receivers for receiving transmission signals from and sending transmitting signals to the plurality of spatially separated antennas, wherein at least some of the second plurality of transmitter/receivers of the second location and the transmitter/receiver of the first location are configured to perform FD signal combining of the signals received.

According to some embodiments of the invention, the transmissions include continuous carrier transmissions. According to some embodiments of the invention, the transmissions include single carrier transmissions.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of a communication system configured to use Space Diversity (SD);

FIG. 2 is a simplified illustration of a communication system configured to use Frequency Diversity (FD);

FIG. 3 is a simplified illustration of a communication system configured to use Adaptive Coding and Modulation (ACM);

FIG. 4A is a simplified illustration of a communication system configured to use a combination of SD and FD according to an example embodiment of the invention;

FIG. 4B is a simplified illustration of a communication system configured to use a combination of SD and FD according to another example embodiment of the invention;

FIG. 5A is a simplified graph illustrating reception quality of a communication system configured to use a combination of FD and ACM;

FIG. 5B is a simplified illustration of a wireless communication system configured to use a combination of FD and ACM according to an example embodiment of the invention;

FIG. 6 is a simplified illustration of a communication system configured to use a combination of FD, SD and ACM according to an example embodiment of the invention;

FIG. 7 is a simplified illustration of a communication system configured to use a combination of FD, SD and ACM according to an example embodiment of the invention; and

FIG. 8 is a simplified flow chart illustration of a method of communicating over a wireless point-to-point communication system according to an example embodiment of the invention.

### DESCRIPTION OF SPECIFIC EMBODIMENTS OF THE INVENTION

The present invention, in some embodiments thereof, relates to the field of wireless communication and, more specifically but not exclusively, to point-to-point communication systems, and, even more specifically but not exclusively, to wireless point-to-point communication systems such as employed by cellular backhaul networks or other wireless networks in microwave and millimeter waves.

### INTRODUCTION

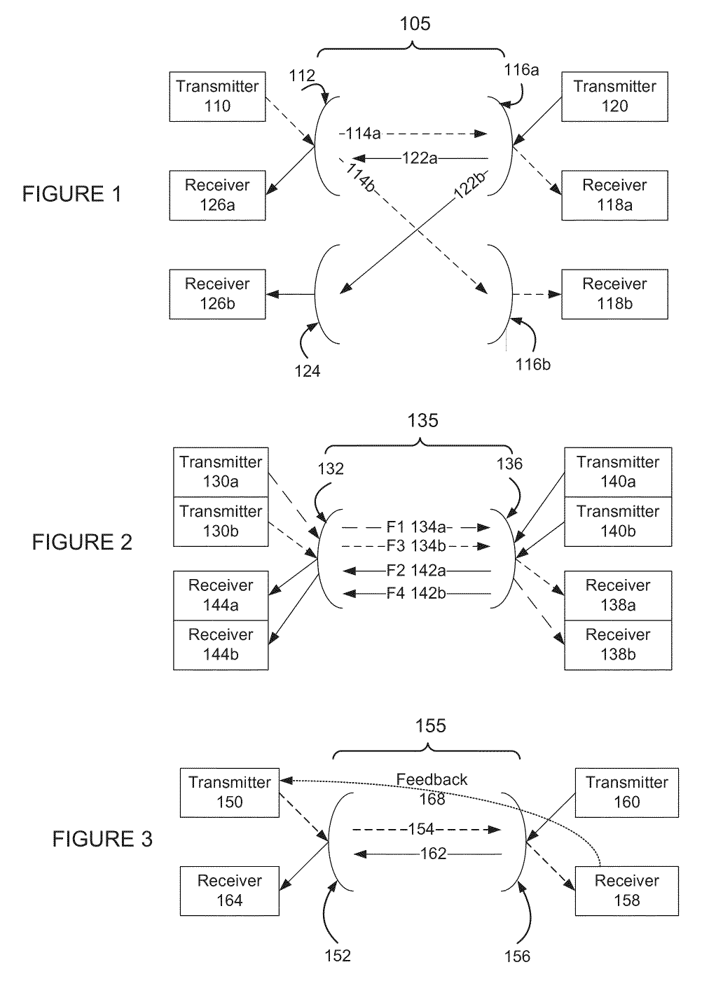

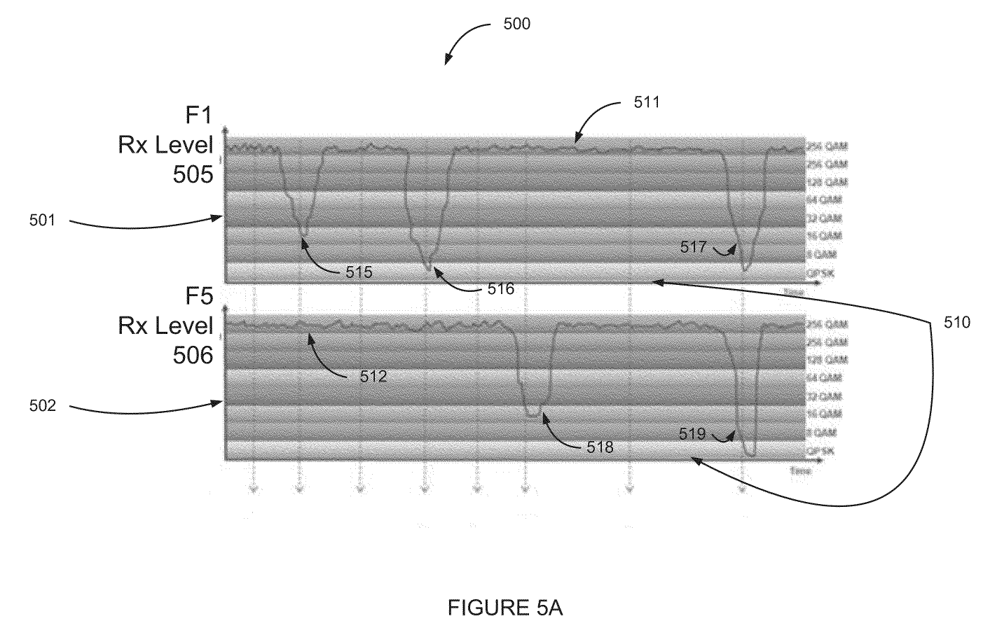

For purposes of better understanding some embodiments of the present invention, as illustrated in FIGS. 4A, 4B, 6, and 7 of the drawings, reference is first made to FIG. 1, which is a simplified illustration of a communication system configured to use Space Diversity (SD).

FIG. 1 depicts a full-duplex communication link 105. Signals 114a 114b are transmitted from left to right (dashed lines) and signals 122a 122b are transmitted from right to left (solid lines). On each side of the link 105 there is one transmitter 110 120 and two receivers 118a 118b 126a 126b, and a total of 4 antennas 112 116a 116b 124. The receivers 118a 118b 126a 126b in each side combine their signals in such a way that when a signal to one of the receivers degrades, the other receiver tries to recover the transmitted information. Such combining by receivers is termed herein SD-combining.

Optionally, a carrier frequency of each of the two signals 114 and 122 is different in order to avoid interference.

The term “combine” in all its grammatical forms, as applied to combining communication signals, is used throughout the present specification and claims to mean one or more of: selecting a best communication signal; performing a manipulation on the communication signals to produce a third signal with a potentially better quality.

While this architecture is common and useful it has some drawbacks. The first is that two antennas are placed on each side of the link but only one is transmitting. This implies a waste of an antenna resource. The second is that often large construction elements, such as tall poles, are required on each side of the link 105 for locating the antennas 112 and 124, and 116a and 116b, so as to have a large enough separation. The large separation is desired so that two received signals 114a and 114b, or 122a and 122b, should not fade together. Their fading should be uncorrelated, and hence, they should be separated in space.

It is noted that often antennas are the most, or one of the most, expensive components in setting up a point-to-point communication link.

Causes for fading which can be overcome by SD include, for example, signal reflections from the ground or the atmosphere. The reflections may change with time of the day. Phase difference between a direct beam and a reflected beam may change with the time of day. The fading may depend on temperature, and/or humidity and/or precipitation.

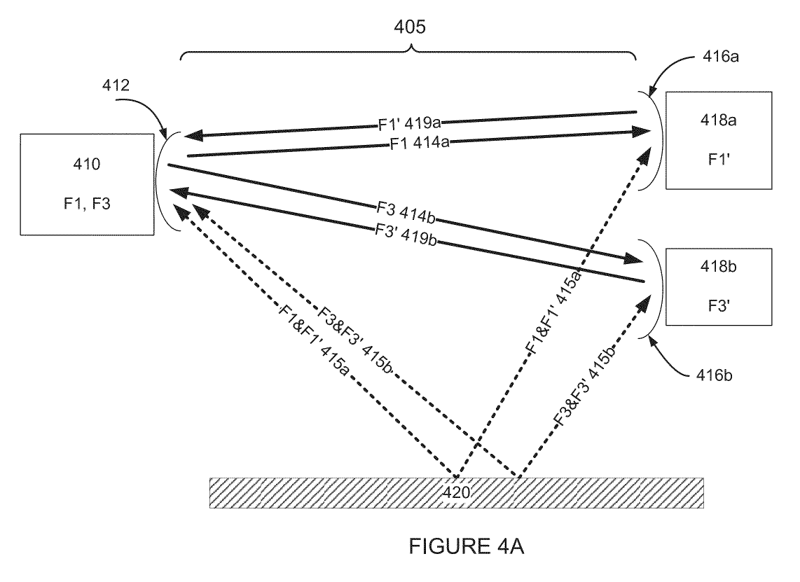

Reference is now made to FIG. 2, which is a simplified illustration of a communication system configured to use Frequency Diversity (FD).

FIG. 2 depicts a full-duplex communication link 135. Signals 134a 134b are transmitted from left to right (dashed lines) using different frequencies F1 and F3, and return signals 142a 142b are transmitted from right to left (solid lines) using different frequencies F2 and F4. On each side of the link 135 there are transmitters 130a and 130b, 140a and 140b; and two receivers 138a and 138b, and 144a and 144b, and a total of just 2 antennas 132 136.

The FD setup depicted by FIG. 2 uses two different frequencies for transmitting the same information with a single set of antennas. While the FD method uses a single antenna on each side of the link 135, the FD method requires two different carrier frequencies for each direction, and two transmitters and two receivers for each direction. A penalty for using the FD method is typically an increased carrier frequency cost, and an inefficient utilization of spectrum. In some cases, performance of the FD method is not good enough. For example, the frequencies allowed for use may not be sufficiently separated, due to standards limitations, and not provide enough frequency diversity.

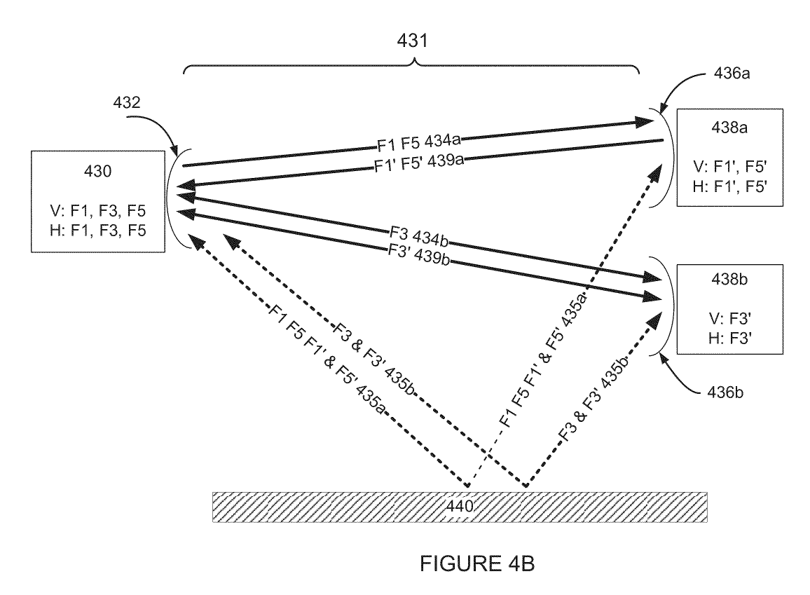

Reference is now made to FIG. 3, which is a simplified illustration of a communication system configured to use Adaptive Coding and Modulation (ACM).

FIG. 3 depicts a full-duplex communication link 155. A signal 154 is transmitted from left to right (dashed line), and a return signal 162 is transmitted from right to left (solid line). On each side of the link 155 there are transmitters 150 and 160, and receivers 158 and 164, and 2 antennas 152 and 156. A feedback signal 168 from a receiver 158 on one side is sent back to an ACM unit (not shown) on the other side, which may change transmission characteristics of a transmitter 150 on the other side.

Optionally there may be another feedback signal (not shown) going from the other receiver 164 in the opposite direction to the other transmitter 160 and affecting the other transmitter 160.

Typically a second feedback signal in an opposite direction is not needed. Typically problems in a communication system using ACM affect communications in both directions similarly, and only one feedback signal 168 is used.

Using ACM potentially increases link 155 availability by reducing the link's communication rate whenever conditions degrade. Using the ACM method is typically the cheapest, since it uses a single set of antennas, and a single transmitter and receiver on each side of the link, as shown in FIG. 3. One drawback of using ACM is that it requires feedback 168 from the receiver 158 to the transmitter 150 in order to request switching a modulation or a code rate when link conditions change. The feedback should be provided rapidly enough so as to avoid errors in fast fading situations. This is sometimes not possible.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In light of the drawbacks mentioned above, embodiments of the invention offer a better communication method by combining advantages of two or more of the methods described above, while avoiding their drawbacks. The combining potentially provides an improved immunity to fading conditions, since several countermeasures are taken simultaneously.

SD+FD

In some embodiments, a combination of SD and FD is used.

Reference is now made to FIG. 4A, which is a simplified illustration of a communication system configured to use a combination of SD and FD according to an example embodiment of the invention.

FIG. 4A depicts a full-duplex communication link 405. Signals 414a and 414b are transmitted (solid lines) from one or more transmitter/receiver 410 at different frequencies F1 and F3, via an antenna 412, and signals 419a 419b are transmitted from right to left at frequencies F1′ and F3′ via two spatially separated antennas 416a and 416b correspondingly by transmitter/receivers 418a and 418b correspondingly.

On a first side of the link 405 there is one or more transmitter/receiver 410 and one antenna 412. On a second side of the link 405 there are the transmitter/receivers 418a and 418b and two corresponding antennas 416a and 416b.

The carrier frequencies F1′ F3′ of each of the two signals 419a and 419b are different, obtaining frequency diversity at the receiver 410.

FIG. 4A shows that on one side of the link 405 (the left side) there is a single antenna 412; on the other side of the link 405 (the right side) there are two antennas 416a 416b separated in space.

FIG. 4A also demonstrates reflection signals 415a 415b (dashed lines) from an example reflective object 420 which may lead to a dispersive channel response on either side of the link 405.

Communication in both directions is done using four frequencies: F1 and F3 in one direction and F1′ and F3′ in the other direction.

In some embodiments, F1 is equal to F1′ and F3 is equal to F3′.

FIG. 4A depicts an example embodiment where both frequency and space diversity are achieved.

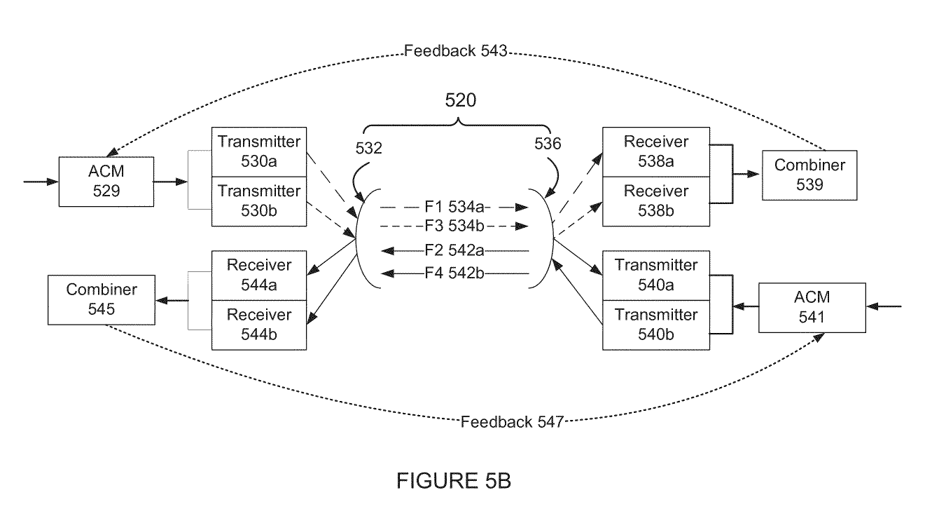

In some embodiments the receivers 418a and 418b on the right in FIG. 4A are optionally connected to a frequency diversity combining unit, a feature which is described in more detail below with reference to FIG. 5B. The combination of space-diversity and frequency diversity of the example embodiment of FIG. 4A potentially increases immunity from fading relative to each of the diversity alternatives separately.

In some embodiments the diversity combining unit selects the signal with the better quality.

In some embodiments the diversity combining unit sums the received signals in an appropriate phase and gain such that the resulting signal has a quality at least as good as that of the better signal received.

In some embodiments the diversity combining unit sums the received signals in an appropriate phase such that the quality of the resulting signal is maximized.

In some embodiments the diversity combining unit selects a few of the input signals and sums them in an appropriate phase and gain such that the quality of the resulting signal is maximized.

It is noted that the embodiment depicted by FIG. 4A provides two lines-of-sight, thereby providing SD in both directions.

It is noted that the embodiment depicted by FIG. 4A provides two frequencies, thereby providing FD in both directions.

Reference is now made to FIG. 4B, which is a simplified illustration of a communication system configured to use a combination of SD and FD according to another example embodiment of the invention.

FIG. 4B depicts a full-duplex communication link 431. Signals 434a and 434b are transmitted from left to right by one or more transmitter/receivers 430 at different frequencies F1 F3 and F5, and the signals 439a 439b are also transmitted from right to left at frequencies F1′ and F5′, and F3′ correspondingly by transmitter/receivers 438a and 438b correspondingly. On a first side of the link 431 there is are one or more transmitter/receivers 430 and one antenna 432. On a second side of the link 431 there are transmitter/receivers 438a and 438b and two corresponding antennas 436a and 436b.

On one side of the link 431 (the left side) there is a single antenna 432; on the other side of the link 431 (the right side) there are two antennas 436a 436b separated in space. In the embodiment depicted by FIG. 4B, there are three pairs of frequencies: F1 and F1′, F3 and F3′, F5 and F5′.

FIG. 4B also depicts reflection signals 435a 435b (dashed lines) from an example reflective object 440 which may lead to a dispersive channel response on either side of the link 431.

Communication in both directions is optionally done using all three frequencies: F1, F3 and F5 in one direction and F1′, F3′ and F5′ in the other direction.

FIG. 4B depicts an example embodiment where both frequency and space diversity are achieved.

In some embodiments the upper antenna 436a on the right in FIG. 4B the transmitter/receiver 438a optionally performs frequency-diversity combining.

In some embodiments output of the transmitter/receivers 438a 438b is optionally combined. The space-diversity of the antennas 436a 436b of the example embodiment of FIG. 4B potentially increases immunity from fading.

In some embodiments the transmitter/receivers 438a and 438b on the right in FIG. 4B are optionally connected to a diversity combining unit. The combination of space-diversity and frequency diversity of the example embodiment of FIG. 4B potentially increases immunity from fading relative to each of the diversity alternatives separately.

In some embodiments the diversity combining unit selects the signal with the better quality.

In some embodiments the diversity combining unit sums the received signals in an appropriate phase and gain such that the resulting signal has a quality at least as that of the best signal it received.

In some embodiments the diversity combining unit sums the received signals in an appropriate phase such that the quality of the resulting signal is maximized.

In some embodiments the diversity combining unit selects a few of the input signals and sums them in an appropriate phase and gain such that the quality of the resulting signal is maximized.

In some embodiments two different signal polarizations are optionally used for each frequency.

FIG. 4B depicts such an embodiment, without meaning to limit the embodiment of FIG. 4A not to use signal polarizations, and without meaning to limit the embodiment of FIG. 4B necessarily to use signal polarizations.

FIG. 4B depicts communication optionally in two polarizations—Vertical (V) and Horizontal (H).

It is noted that when FD only is used, an ACM mechanism is capable of maintaining the communication link despite fading but at a cost—in case of fading of several frequencies simultaneously, the communication rate decreases due to switching to a lower constellation. FIG. 4B demonstrates that adding SD is useful. SD reduces the probability that several frequencies fade simultaneously.

Reference is now made to FIG. 5A, which is a simplified graph 500 illustrating reception quality of a communication system configured to use a combination of FD and ACM.

The graph 500 of FIG. 5A includes two sub-graphs 501 502.

Each one of the sub-graphs 501 502 includes an x-axis 510 depicting time, and respective y-axes 505 506 depicting reception level lines 511 512 at frequencies F1 and F5 respectively.

FIG. 5A illustrates why space diversity can be a useful addition to frequency diversity. FIG. 5A depicts the reception power level lines 511 512 in two receivers using two different frequencies F1 and F5.

The example of FIG. 5A does not depict a case of an SD signal—the two signals of FIG. 5A are transmitted from one antenna at two different frequencies.

The upper line 511 displays three time intervals 515 516 517 in which the received signal has degraded. The lower line displays two time intervals 518 519 in which the received signal has degraded. The time interval 517 which is when fading occurred at frequency F1 coincides with the time interval 519 which is when fading occurred at frequency F5. A communication system using only FD would suffer from fading at the time interval of coinciding fading, while a communication system also using SD might not suffer from fading.

A non-limiting example in which fading can happen in different frequencies is a case where two frequencies are not separated sufficiently, and fading of the two frequencies may be correlated. Adding different line-of-sight paths for the wireless communication link can reduce the correlation.

FD+ACM

Implementing FD+ACM can be problematic, since if two signals at different frequencies are carrying the same data, and one of the signals fades, a standard ACM mechanism would need to reduce the communication rate on both signals, since one of the signals can no longer carry the same amount of data.

In some embodiments, FD and ACM mechanisms are used together by combining received signals.

Reference is now made to FIG. 5B, which is a simplified illustration of a communication system configured to use a combination of FD and ACM according to an example embodiment of the invention.

FIG. 5B depicts a full-duplex communication link 520. Signals 534a 534b are transmitted from left to right (dashed lines) using different frequencies F1 and F3, and return signals 542a 542b are transmitted from right to left (solid lines) using different frequencies F2 and F4. On each side of the link 520 there are transmitters 530a and 530b, 540a and 540b; and receivers 538a and 538b, and 544a and 544b, and antennas 532 536.

The FD setup depicted by FIG. 5B uses two different frequencies for transmitting the same information with a single set of antennas.

The receivers 538a and 538b both provide an output signal to an FD signal combiner 539.

In some embodiments, the FD signal combiner 539 selects a better output signal from the receivers 538a 538b. In some embodiments the better signal is selected based on an error rate. In some embodiments the better signal is selected based on closeness of received symbols to expected symbols.

In some embodiments the output signals from the receivers 538a 538b are added after correcting for appropriate phase and/or gain. It is noted that since there is frequency diversity, the appropriate phase constantly shifts.

It is noted that when the signals 534a 534b are carrying the same data, and one of them fades and needs to reduce the communication rate using ACM, it can no longer carry the same data as the other signal.

In the example embodiment of FIG. 5B the received signals 534a 534b are optionally combined by the FD signal combiner 539. If quality of the combined signal is not sufficient, the FD signal combiner 539 sends a feedback signal 543 to an ACM unit 529 which optionally causes both transmitters 530a and 530b reduce the communication rate in both frequencies F1 and F3. This way both signals 534a 534b have the same data capacity, and the same data can be transmitted.

FIG. 5B also depicts an FD signal combiner 545, an ACM unit 541, and a feedback signal 547, for providing an FD combining mechanism and an ACM and feedback mechanism for the right to left communication signals 542a 542b.

In some embodiments, if quality of a combined signal is not sufficient, the transmitters use the ACM mechanism to reduce the communication rate in the received frequencies. Using this method the same data may be transmitted over different frequencies.

SD+FD+ACM

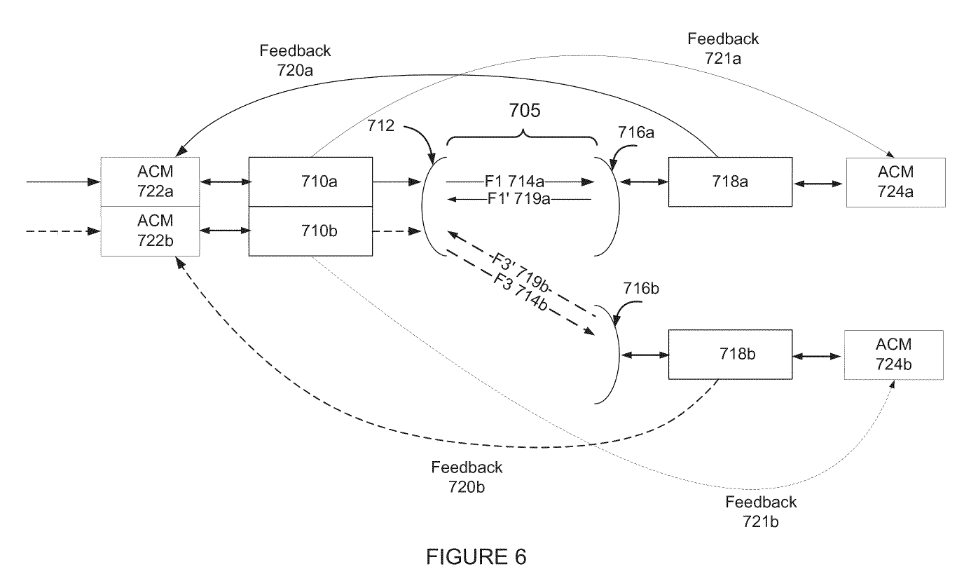

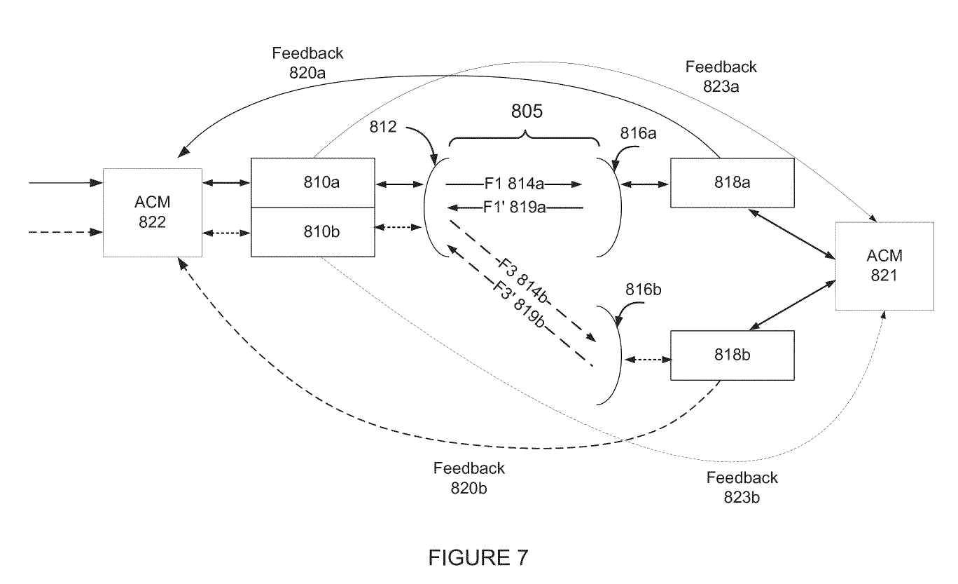

In some embodiments, both FD and ACM are combined, as is depicted in FIGS. 6 and 7 which are described below. In such embodiments, signals of different frequencies are combined, as is typically done in FD applications, and optionally, if required, modulation and/or code are modified using an ACM mechanism. The embodiments which combine FD and ACM mechanisms enable maintaining a higher communication rate together with higher availability than with a single mechanism. When two (or more) signal frequencies fade simultaneously, an SD mechanism (not shown in FIG. 5A) provides extra diversity for maintaining high throughput and availability.

Wholly Redundant, not Redundant, or Partly Redundant Transmission

In some embodiments, the same information is transmitted via different frequencies in an FD configuration, as well as via different paths in an SD configuration, in a wholly redundant fashion. This potentially allows both the FD configuration and the SD configuration to improve availability over a configuration in which FD and SD are not both practiced together.

In some embodiments, the same information is split among different frequencies in an FD configuration, in a wholly not redundant fashion. When information being transmitted is split between carrier frequencies, it is potentially possible to reduce the bit rate at each of the carrier frequencies compared with the case of redundancy, by reducing the modulation. This potentially increases immunity to fading.

In some embodiments, some of the same information is transmitted redundantly, and some information is transmitted not redundantly. The redundant information potentially benefits from the mechanisms of FD and SD, as well as a somewhat reduced bit rate due to other information not being transmitted redundantly. The somewhat reduced bit rate allows, for example, optionally using an ACM constellation which is more error resistant than a non-reduced bit rate. The non-redundant information also potentially benefits from a somewhat reduced bit rate which potentially somewhat increases immunity to fading.

In some embodiments, data which is associated with a higher quality of service is optionally transmitted redundantly, and data which is associated with a lower quality of service is optionally transmitted non-redundantly.

It is noted that more than two frequencies, and more than three frequencies, may optionally be used, based upon the description of using two and/or three frequencies provided by the example embodiments and the Figures.

It is noted that more than two space-diversity mechanisms, and more than three space-diversity mechanisms, may be used, based upon the description of using two and/or three space-diversity mechanisms provided by the example embodiments and the Figures.

When information is split among several frequency diversity channels, flexibility is optionally provided in determining a bit rate for each of the several frequency diversity channels. For example—if there is a deep fade in a first carrier frequency, e.g. F1 714a of FIG. 6, but another carrier frequency, e.g. F3 714b of FIG. 6, has good channel conditions, the bit rate for the first carrier frequency, F1, is optionally decreased, and the bit rate for the second carrier frequency, F3, is optionally increased.

When information is split among several spatially diverse channels, flexibility is optionally provided in determining a bit rate for each of the several spatially diverse channels. For example—if there is a deep fade in one spatial channel, but another spatial channel has good channel conditions, the bit rate for the first channel, e.g. F1 714a of FIG. 6, is optionally decreased, and the bit rate for the second channel, e.g. F3 714b of FIG. 6, is optionally increased.

In some embodiments, ACM is applied separately to each of the channels.

The above flexibility is described in the following figures. FIG. 6 demonstrates a system in which each of the transmitters has its modulation and code determined by feedback from a receiver associated with the transmitter.

Reference is now made to FIG. 6, which is a simplified illustration of a communication system configured to use a combination of FD, SD and ACM according to an example embodiment of the invention.

FIG. 6 depicts a full-duplex communication link 705.

Signals 714a and 714b are transmitted from left to right by two transmitter/receivers 710a 710b at different frequencies F1 and F3, and received by two SD antennas 716a 716b. Two transmitter/receivers 718a 718b receive signals 714a and 714b from the antennas 716a 716b.

The two transmitter/receivers 718a 718b each generate a feedback signal 720a 720b and transmit the feedback signals 720a 720b back to ACM units 722a 722b.

In some embodiments, the feedback signals 720a 720b may cause each one of the ACM units 722a 722b to cause a corresponding transmitter/receiver 710a 710b to change coding and/or modulation in its transmission.

Signals 719a and 719b are transmitted from right to left by two transmitter/receivers 718a 718b at different frequencies F1′ and F3′, via two antennas 716a 716b, and received by the antenna 712. The two transmitter/receivers 710a 710b receive signals 719a and 719b from the antenna 712.

The two transmitter/receivers 710a 710b each generate a feedback signal 721a 721b and transmit the feedback signals 721a 721b back to ACM units 724a 724b.

In some embodiments, the feedback signals 721a 721b may cause each one of the ACM units 724a 724b to cause a corresponding transmitter/receiver 718a 718b to change coding and/or modulation in its transmission.

In some embodiments, the feedback signals 720a 720b may cause the ACM units 722a 722b to cause both transmitter/receivers 710a 710b to change coding and/or modulation in their transmissions.

In some embodiments, if the two ACM units 722a 722b do not agree on a same coding/modulation for the two transmitter/receivers 710a 710b, the two ACM units 722a 722b cause both transmitters to use a lower one (worst case scenario) of the different coding/modulation possibilities.

In some embodiments, the feedbacks 720a 720b from both receivers are taken into account by the ACM units 722a 722b, for example increasing a bit rate of one transmitter when the bit rate of the other transmitter is reduced.

It is noted that combining FD and SD potentially reduce correlation between fading of signals in receiving terminals. Often, there can be fading in one receiver while another receiver maintains a high-quality signal or even an improved signal quality relative to a case in which there is no fading.

It is noted that using an ACM mechanism in conjunction with FD and SD enables increasing a communication rate in one link while reducing the communication rate in the other. One example way to do so is described above with reference to FIG. 5B. A potential benefit of doing so is that each of the links is provides an optimized data communication rate using the ACM mechanism.

In some embodiments, where ACM mechanisms are separate, an ACM mechanism which is connected to a better-quality signal might be set not to increase the communication rate beyond what is required.

In some embodiments a first ACM unit receives information about another ACM unit, controlling another link, reducing its communication rate due to fading, and the first ACM mechanism optionally assists by increasing its communication rate.

In some embodiments control of ACM for more than one communication link is combined within one ACM unit. In some embodiments a single mechanism is defined for controlling a code-rate and modulation of two or more links.

Reference is now made to FIG. 7, which is a simplified illustration of a communication system configured to use a combination of FD, SD and ACM according to an example embodiment of the invention.

FIG. 7 depicts a full-duplex communication link 805.

Signals 814a and 814b are transmitted from left to right by two transmitter/receivers 810a 810b at different frequencies F1 and F3, and received by two SD antennas 816a 816b. Two transmitter/receivers 818a 818b receive signals 814a and 814b from the antennas 816a 816b.

The two transmitter/receivers 818a 818b each generate a feedback signal 820a 820b and transmit the feedback signals 820a 820b back to an ACM unit 822.

In some embodiments, the feedback signals 820a 820b may cause the ACM unit 822 to cause one or both of the transmitters 810a 810b to change coding and/or modulation in its transmission.

In some embodiments, the feedback signals 820a 820b from both receivers are taken into account by the ACM unit 822, for example increasing a bit rate of one transmitter when the bit rate of the other transmitter is reduced.

Signals 819a and 819b are transmitted from right to left by two transmitter/receivers 818a 818b at different frequencies F1′ and F3′ via two antennas 816a 816b, and received by the antenna 812. The two transmitter/receivers 810a 810b receive the signals 819a and 819b from the antenna 812.

The two transmitter/receivers 810a 810b each generate a feedback signal 823a 823b and transmit the feedback signals 823a 823b back to an ACM unit 821.

In some embodiments, the feedback signals 823a 823b may cause the ACM unit 823 to cause one or both of the transmitters 818a 818b to change coding and/or modulation in its transmission.

In some embodiments, the feedback signals 823a 823b from both receivers are taken into account by the ACM unit 821, for example increasing a bit rate of one transmitter when the bit rate of the other transmitter is reduced.

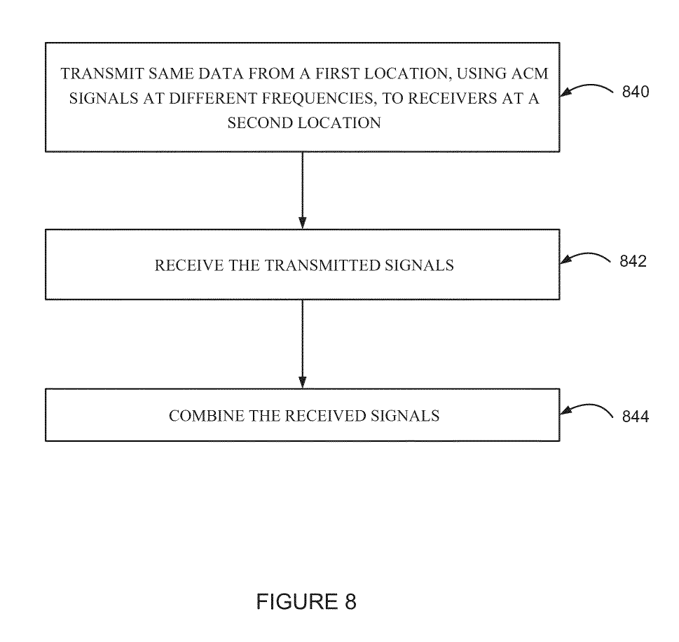

Reference is now made to FIG. 8, which is a simplified flow chart illustration of a method of communicating over a wireless point-to-point communication system according to an example embodiment of the invention.

The method depicted by FIG. 8 includes: transmitting same data from a first location, using each one of a plurality of Adaptive Coding and Modulation (ACM) signals at different frequencies, to receivers corresponding to each one of the frequencies at a second point (840);

receiving the transmitted signals (842); and

combining the received signals (844).

The flowchart of FIG. 8 describes using FD in conjunction with ACM.

In some embodiments, FD and SD are used in conjunction with ACM.

It is expected that during the life of a patent maturing from this application many relevant ACM methods, and many relevant signal combining methods will be developed and the scope of the terms ACM and signal combining are intended to include all such new technologies a priori.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of communicating bi-directionally over a wireless communication system comprising:
sending data from a first location, from a first antenna, over a first plurality of signals at different frequencies, to a second plurality of spatially separated antennas at a second location, each of the second plurality of spatially separated antennas feeding a corresponding transmitter/receiver of a plurality of transmitter/receivers at the second location.

2. The method of claim 1 and further comprising combining the signals received by at least some of the receivers of the second location.

3. The method of claim 2 in which the combining comprises selecting a best signal from the plurality of signals at different frequencies received by the plurality of spatially separated antennas of the second location.

4. The method of claim 2 in which the combining comprises adding the received signals using an appropriate phase shift.

5. The method of claim 2 in which the combining comprises adding the received signals using an appropriate gain.

6. The method of claim 1 in which the communicating is via a continuous carrier wireless point-to-point communication system.

7. The method of claim 1 in which the communicating is via a single carrier wireless communication system.

8. The method of claim 1 in which the plurality of signals comprise three frequencies.

9. The method of claim 8 in which the plurality of spatially separated antennas comprises two antennas.

10. The method of claim 1 in which the sending of data comprises sending same data over the plurality of signals.

11. The method of claim 1 in which the sending data comprises sending different data over different ones of the plurality of signals.

12. The method of claim 1 in which the sending of data comprises partly sending same data over different ones of the plurality of signals and partly sending different data over different ones of the plurality of signals.

13. The method of claim 1 in which the sending of data comprises using Adaptive Coding and Modulation (ACM).

14. The method of claim 1 in which the sending of data comprises decreasing a bit rate of the sending in one or more frequencies.

15. The method of claim 1 in which the sending of data comprises increasing a bit rate of the sending in one or more frequencies.

16. The method of claim 1 and further comprising sending data from the second location, from at least some of the second plurality of spatially separated antennas, over a second plurality of signals at different frequencies, to the first antenna at the first location, the first antenna feeding a transmitter/receiver at the first location.

17. A method of communicating over a wireless communication system comprising:
transmitting same data from a first location, using each one of a plurality of Adaptive Coding and Modulation (ACM) signals at different frequencies, to receivers corresponding to each one of the frequencies at a second location;
receiving the transmitted signals; and
combining the received signals.

18. The method of claim 17 and further comprising using ACM to reduce a communication rate in the different frequencies.

19. A wireless communication system comprising:
at a first location:
a first transmitter/receiver configured for transmitting and receiving over a plurality of frequencies; and
a first antenna connected to the first transmitter/receiver for transmitting and receiving the plurality of frequencies of the first transmitter/receiver;
and, at a second location:
a second plurality of spatially separated antennas for receiving transmissions from the first antenna;
a second plurality of corresponding transmitter/receivers for receiving transmission signals from and sending transmitting signals to the plurality of spatially separated antennas,
wherein at least some of the second plurality of transmitter/receivers of the second location and the transmitter/receiver of the first location are configured to perform FD signal combining of the signals received.

20. The system of claim 19 in which the transmissions comprise continuous carrier transmissions.

21. The system of claim 19 in which the transmissions comprise single carrier transmissions.
